(19) United States
(12) Patent Application Publication
(10) Pub. No.: US 2023/0129675 A1
(43) Pub. Date: Apr. 27, 2023

(54) ITINERARY PROPOSAL SYSTEM, ITINERARY PROPOSAL METHOD, AND COMPUTER PROGRAM

(71) Applicant: NEC Corporation, Minato-ku, Tokyo (JP)

(72) Inventors: Kenichiro FUJIYAMA, Tokyo (JP); Haruki Yokota, Tokyo (JP)

(73) Assignee: NEC Corporation, Minato-ku, Tokyo (JP)

(21) Appl. No.: 17/786,860

(22) PCT Filed: Dec. 25, 2019
(86) PCT No.: PCT/JP2019/050839

§ 371 Date: Dec. 21, 2022

(51) Int. Cl. G06Q 50/14; G06Q 10/0631

(52) U.S. Cl. CPC G06Q 50/14; G06Q 10/06315

(57) ABSTRACT

An itinerary proposal system includes: an accumulation unit that systematizes and accumulates itinerary samples, each of which includes a plurality of travel contents, on the basis of relevance of the travel contents; an extraction unit that searches for and extracts the itinerary sample that matches an inputted condition, from the systematized and accumulated itinerary samples; and a presentation unit that presents the extracted itinerary sample as a proposed itinerary. According to such an itinerary proposal system, it is possible to appropriately propose an itinerary that matches a traveler's condition.

### TECHNICAL FIELD

The present invention relates to an itinerary proposal system, an itinerary proposal method, and a computer program that propose an itinerary or a travel plan that matches a traveler's condition.

### BACKGROUND ART

A known system of this type prepares an itinerary suitable for a traveler. For example, Patent Literature 1 discloses preparing a travel plan by freely selecting and combining tourist contents that match an individual's preference. Patent Literature 2 discloses preparing an itinerary through a travel information management system by inputting information about a travel destination and a travel period.

As another related technique/technology, Patent Literatures 3 and 4 disclose a technique/technology related to ontology.

### CITATION LIST

### Patent Literature

Patent Literature 1: JP2016-018519A

Patent Literature 2: JP2015-018545A

Patent Literature 3: JP2009-193457A

Patent Literature 4: JP2007-317120A

### SUMMARY

### Technical Problem

In order to propose an itinerary suitable for a traveler, deep and wide knowledge on travel contents is required. Therefore, a proposal by a person has a limit in the quality, and there also arises variation in personal quality. Furthermore, a travel content can be also searched for by machine, but it is hard to say that, for example, keyword search can lead to the travel content that fully reflects the traveler's preference. Each of the above-described Patent Literatures does not take into account such technical problems, and there is room for improvement.

The present invention has been made in view of the above problems, and it is an example object of the present invention to provide an itinerary proposal system, an itinerary proposal method, and a computer program that are configured to appropriately propose an itinerary that matches a traveler's condition.

### Solution to Problem

An itinerary proposal system according to an example aspect of the present invention includes: an accumulation unit that systematizes and accumulates itinerary samples, each of which includes a plurality of travel contents, on the basis of relevance of the travel contents; an extraction unit that searches for and extracts the itinerary sample that matches an inputted condition, from the systematized and accumulated itinerary samples; and a presentation unit that presents the extracted itinerary sample as a proposed itinerary.

An itinerary proposal method according to an example aspect of the present invention includes: systematizing and accumulating itinerary samples, each of which includes a plurality of travel contents, on the basis of relevance of the travel contents; searching for and extracting the itinerary sample that matches an inputted condition, from the systematized and accumulated itinerary samples; and presenting the extracted itinerary sample as a proposed itinerary.

A computer program according to an example aspect of the present invention operates a computer to systematize and accumulate itinerary samples, each of which includes a plurality of travel contents, on the basis of relevance of the travel contents; to search for and extract the itinerary sample that matches an inputted condition, from the systematized and accumulated itinerary samples; and to present the extracted itinerary sample as a proposed itinerary.

### Effect of the Invention

According to the itinerary proposal system, the itinerary proposal method, and the computer program in the respective aspects described above, it is possible to appropriately propose an itinerary that matches a traveler's condition.

### BRIEF DESCRIPTION OF DRAWINGS

FIG. 1 is a block diagram illustrating an overall configuration of an itinerary proposal system according to a first example embodiment.

FIG. 2 is a block diagram illustrating a hardware configuration of the itinerary proposal system according to the first example embodiment.

FIG. 3 is a flowchart illustrating a flow of operation of the itinerary proposal system according to the first example embodiment.

FIG. 4 is an image diagram illustrating an example of a travel chart.

FIG. 5 is an image diagram illustrating a display example of a proposed itinerary.

FIG. 6 is an image diagram illustrating a pop-up display example of travel contents included in the proposed itinerary.

FIG. 7 is a block diagram illustrating an overall configuration of an itinerary proposal system according to a second example embodiment.

FIG. 8 a flowchart illustrating a flow of operation of the itinerary proposal system according to the second example embodiment.

FIG. 9 is an image diagram illustrating a specific example of itinerary correction in the itinerary proposal system according to the second example embodiment.

FIG. 10 is a block diagram illustrating an overall configuration of an itinerary proposal system according to a third example embodiment.

FIG. 11 is an image diagram illustrating a specific example of reason presentation in the itinerary proposal system according to the third example embodiment.

FIG. 12 is a block diagram illustrating an overall configuration of an itinerary proposal system according to a fourth example embodiment.

FIG. 13 is an image diagram illustrating a presentation example of virtual experience data generated by the itinerary proposal system according to the fourth example embodiment.

FIG. 14 is a block diagram illustrating an overall configuration of an itinerary proposal system according to a fifth example embodiment.

FIG. 15 is an image diagram illustrating an example of a brochure generated by the itinerary proposal system according to the fifth example embodiment.

### DESCRIPTION OF EXAMPLE EMBODIMENT

Hereinafter, an itinerary proposal system, an itinerary proposal method, and a computer program according to example embodiments will be described with reference to the drawings.

### First Example Embodiment

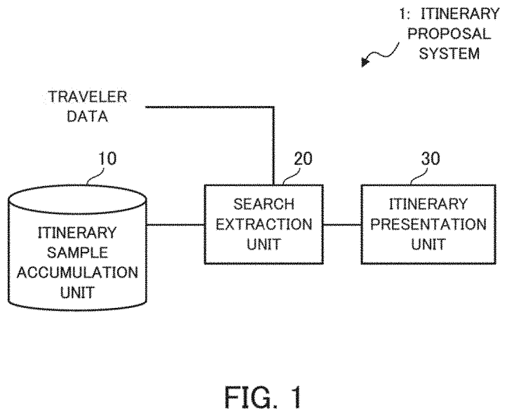

An itinerary proposal system according to a first example embodiment will be described with reference to FIG. 1 to FIG. 6. The following describes an example case in which the itinerary proposal system is configured as a system of a travel agency (i.e., a businessperson who proposes an itinerary to a traveler).

### (System Configuration)

First, with reference to FIG. 1, a description will be given to an overall configuration of the itinerary proposal system according to the first example embodiment. FIG. 1 is a block diagram illustrating the overall configuration of the itinerary proposal system according to the first example embodiment.

In FIG. 1, an itinerary proposal system 1 according to the first example embodiment includes, for example, a server managed by a travel agency. Alternatively, the itinerary proposal system 1 may include a cloud or the like. The itinerary proposal system 1 includes, as processing blocks for realizing its function, an itinerary sample accumulation unit 10, a search extraction unit 20, and an itinerary presentation unit 30.

The itinerary sample accumulation unit 10 is configured to accumulate an itinerary sample including a plurality of travel contents (e.g., tourist spots, accommodation facilities, activities, etc.). The itinerary sample accumulation unit 10 collects and accumulates the itinerary sample, for example, by crawling on the Internet. Alternatively, the itinerary sample accumulation unit 10 may accumulate an itinerary sample that is manually inputted. In addition, the itinerary sample accumulation unit 10 especially systematizes and accumulates a plurality of itinerary samples, on the basis of the relevance of the travel contents included in each itinerary sample. Specifically, the itinerary sample accumulation unit 10 systematizes and accumulates a plurality of itinerary samples by using an ontology technology/technique. A detailed description of the ontology technology is omitted because it is an existing technology, but the itinerary sample accumulation unit 10 accumulates the itinerary sample, for example, in a state in which concept search using the relevance of the travel contents is available.

Furthermore, the itinerary accumulated in the itinerary sample accumulation unit 10 is an itinerary in which the included travel contents are consistent. The term “consistent” here means that a relationship/relevancy among the travel contents is taken into account and incorporated into the itinerary sample in an appropriate condition. For example, the itinerary accumulated in the itinerary sample accumulation unit 10 includes such travel contents that a discount is given in a particular combination. Alternatively, the itinerary accumulated in the itinerary sample accumulation unit 10 may incorporate therein the travel contents so as to make a route that is efficient in distance or means of transportation. Alternatively, the itinerary accumulated in the itinerary sample accumulation unit 10 incorporates therein the travel contents in the order that allows reduced congestion. Alternatively, the itinerary accumulated in the itinerary sample accumulation unit 10 incorporates therein the travel contents such that an arrival time to each travel content is an appropriate time.

The search extraction unit 20 is configured to search for and extract an itinerary sample that matches traveler data that are inputted (e.g., an attribute information on a traveler, information about desired conditions of a travel, etc.) from the plurality of itinerary samples accumulated in the itinerary sample accumulation unit 10. Specifically, the search extraction unit 20 extracts the itinerary sample that matches the traveler data by the concept search, by utilizing the fact that the itinerary sample accumulation unit 10 systematizes and accumulates the plurality of itinerary samples. The search extraction unit 20 extracts the itinerary sample including not only a travel content related to a keyword included in the traveler data, but also a travel content related to a keyword associated with the above-described keyword. The search extraction unit 20 may extract a plurality of itinerary samples.

The itinerary presentation unit 30 is configured to present the itinerary sample extracted by the search extraction unit 20 to a system user (e.g., a staff of a travel agency, or a traveler who is a customer, etc.). The itinerary presentation unit 30 outputs and displays information about the extracted itinerary sample on a display apparatus provided with a display (e.g., a personal computer, a tablet, a smart phone, or the like).

### (Hardware Configuration)

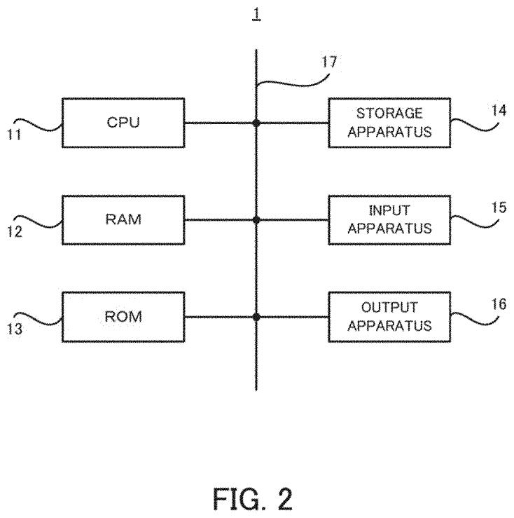

Next, a hardware configuration of the itinerary proposal system 1 according to the first example embodiment will be described with reference to FIG. 2. FIG. 2 is a block diagram illustrating the hardware configuration of the itinerary proposal system according to the first example embodiment.

As illustrated in FIG. 2, the itinerary proposal system 1 according to the first example embodiment includes a CPU (Central Processing Unit) 11, a RAM (Random Access Memory) 12, a ROM (Read Only Memory) 13, and a storage apparatus 14. The itinerary proposal system 1 may also include an input apparatus 15 and an output apparatus 16.

CPU 11, RAM 12, ROM 13, the storage apparatus 14, the input apparatus 15, and the output apparatus 16 are connected through a data bus 17.

The CPU 11 reads a computer program. For example, the CPU 11 is configured to read a computer program stored by at least one of the RAM 12, the ROM 13 and the storage apparatus 14. Alternatively, the CPU 11 may read a computer program stored by a computer readable recording medium by using a not-illustrated recording medium read apparatus. The CPU 11 may obtain (i.e., read) a computer program from a not-illustrated apparatus that is located outside the itinerary proposal system 1 through a network interface. The CPU 11 controls the RAM 12, the storage apparatus 14, the input apparatus 15, and the output apparatus 16 by executing the read computer program. Especially in the example embodiment, when the CPU 11 executes the read computer program, a functional block for proposing an itinerary is implemented in the CPU 11 (see FIG. 1).

The RAM 12 temporarily stores the computer program to be executed by the CPU 11. The RAM 12 temporarily stores the data that is temporarily used by the CPU 11 when the CPU 11 executes the computer program. The RAM 12 may be, for example, a D-RAM (Dynamic RAM).

The ROM 13 stores the computer program to be executed by the CPU 11. The ROM 13 may otherwise store fixed data. The ROM 13 may be, for example, a P-ROM (Programmable ROM).

The storage apparatus 14 stores the data that is stored for a long term by the itinerary proposal system 1. The storage apparatus 14 may operate as a temporary storage apparatus of the CPU 11. The storage apparatus 14 may include, for example, at least one of a hard disk apparatus, a magneto-optical disk apparatus, an SSD (Solid State Drive), and a disk array apparatus.

The input apparatus 15 is an apparatus that receives an input instruction from a user of the itinerary proposal system 1. The input apparatus 15 may include, for example, at least one of a keyboard, a mouse, and a touch panel.

The output apparatus 16 is an apparatus that outputs information about the itinerary proposed system 1 to the outside. For example, the output apparatus 16 may be a display apparatus (e.g., a display) that is configured to display the information about the itinerary proposal system 1.

### (Flow of Operation)

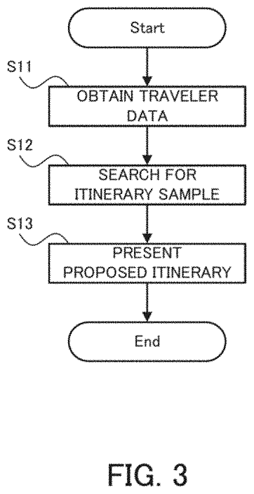

Next, with reference to FIG. 3, a flow of operation of the itinerary proposal system 1 according to the first example embodiment will be described. FIG. 3 is a flowchart illustrating the flow of the operation of the itinerary proposal system according to the first example embodiment. Incidentally, it is assumed that the following operation is an operation when presenting an itinerary sample and that an operation of systematizing and accumulating the itinerary samples is performed in advance.

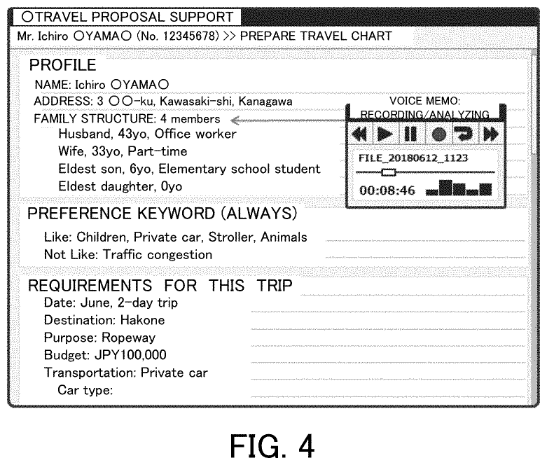

As illustrated in FIG. 3, the itinerary proposal system 1 according to the first example embodiment firstly obtains the traveler data (step S11). The traveler data are inputted to the itinerary proposal system 1, for example, as a travel chart prepared by a travel agency. Referring now to FIG. 4, the travel chart will be specifically described. FIG. 4 is an image diagram illustrating an example of the travel chart.

As illustrated in FIG. 4, the travel chart includes a profile information on a traveler (e.g., name, address, family structure, etc.), a preference keyword, and a condition for this trip. The travel chart is prepared, for example, on the basis of information obtained from a traveler by a staff of a travel agency. The travel chart may be prepared by an input of the staff of the travel agency or may be prepared automatically by voice input.

Back in FIG. 3, when the traveler data are obtained, the search extraction unit 20 performs the concept search on the itinerary samples accumulated in the itinerary sample accumulation unit 10 (step S12). Specifically, the search extraction unit 20 searches for and extracts the itinerary sample that matches the traveler by using a keyword included in the traveler data or a keyword associated with the above-described keyword.

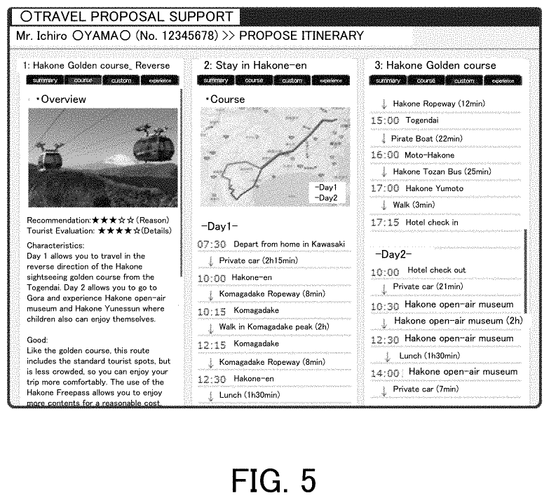

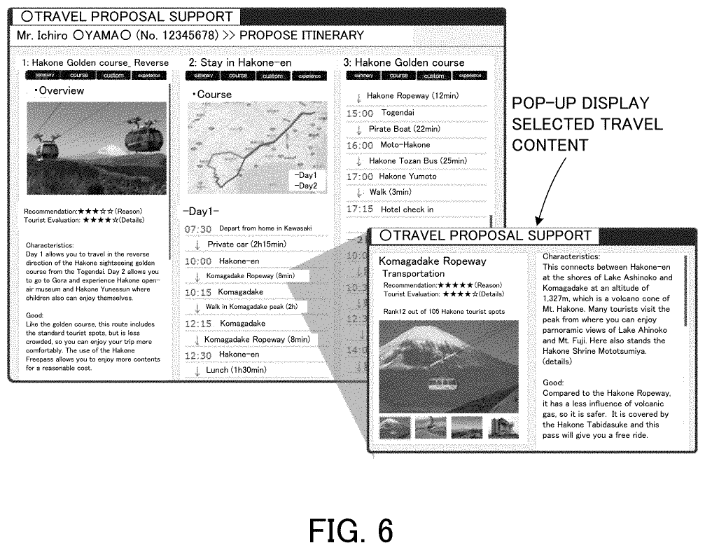

Subsequently, the itinerary presentation unit 30 presents the itinerary extracted by the search extraction unit 20 (hereinafter referred to as a “proposed itinerary” as occasion demands) (step S13). Referring now to FIG. 5 and FIG. 6, the presentation of the proposed itinerary will be specifically described. FIG. 5 is an image diagram illustrating a display example of the proposed itinerary. FIG. 6 is an image diagram illustrating a pop-up display example of the travel contents included in the proposed itinerary.

As illustrated in FIG. 5, the proposed itinerary is presented as an itinerary that includes not only information about characteristics and evaluation of the itinerary, but also information about the travel contents included in the itinerary. The proposed itinerary may include, for example, not only information about a route and a time required between the travel contents, but also information about a degree of recommendation the itinerary (a degree of match with the traveler data), evaluation from other travelers, characteristics of the itinerary, advantages and disadvantages of the itinerary, a budget of the itinerary, and the like. The proposed itinerary may also be presented in a comparable layout of a plurality of itineraries. In the example illustrated in the FIG. 5, three itineraries are presented vertically side by side. Incidentally, the display example in FIG. 5 is only an example, and the proposed itinerary may be displayed in other aspects.

As illustrated in FIG. 6, information on details of the travel contents included in the proposed itinerary may be displayed. Specifically, when a travel content is selected, information about the travel content may be displayed in a pop-up window. This makes it easier to understand what the proposed itinerary is like.

### (Technical Effect)

Next, a technical effect obtained by the itinerary proposal system 1 according to the first example embodiment will be described.

As described in FIG. 1 to FIG. 6, in the itinerary proposal system 1 according to the first example embodiment, the itinerary sample that matches a traveler is extracted from the plurality of itinerary samples accumulated. Especially in the example embodiment, since the itinerary samples are systematized and accumulated, it is possible to extract the itinerary sample that matches a traveler by utilizing the concept search.

Specifically, it is possible to extract and present an itinerary sample that cannot be extracted by keyword search, synonym search, or the like. For example, the use of the concept search makes it possible to extract an itinerary sample including travel contents corresponding to an ambiguous concept such as “quiet”. Alternatively, the use of the keyword associated from the keyword included in the traveler data makes it possible to extract an itinerary sample including travel contents that are unexpected (i.e., that are difficult to think of from the traveler data).

Incidentally, when an attempt is made to realize the above-described itinerary presentation without using the itinerary proposal system 1 according to the first example embodiment, for example, deep and wide knowledge on various travel contents is required. It is, however, hard to enhance the quality of the itinerary proposal because of limitations and individuality of human resources, and there also arises variation in personal quality.

The itinerary proposal system 1 according to the first example embodiment, however, is configured to search for and extract an itinerary by the concept search, by systematizing and accumulating the itinerary samples. Therefore, according to the itinerary proposal system 1 in the first example embodiment, it is possible to propose an appropriate itinerary that matches a traveler's preference.

### Second Example Embodiment

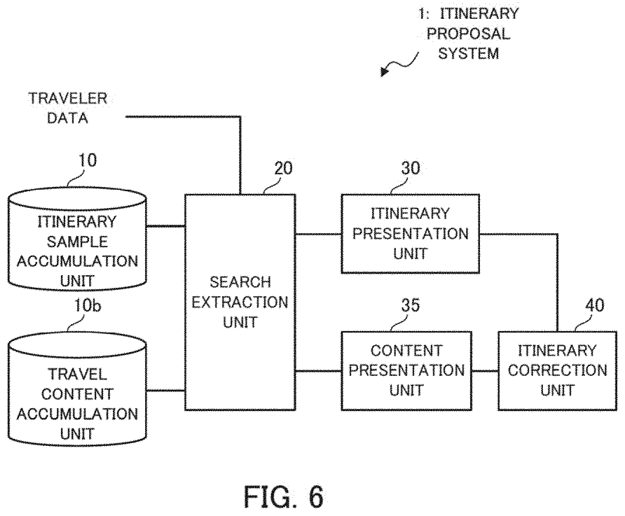

Next, the itinerary proposal system 1 according to a second example embodiment will be described with reference to FIG. 7 to FIG. 9. The second example embodiment is partially different from the first example embodiment described above only in the configuration and operation, and is substantially the same in the other parts. Therefore, the parts that differ from the first example embodiment will be described in detail below, and the other overlapping parts will not be described as occasion demands.

### (System Configuration)

First, with reference to FIG. 7, an overall configuration of the itinerary proposal system 1 according to the second example embodiment will be described. FIG. 7 is a block diagram illustrating the overall configuration of the itinerary proposal system according to the second example embodiment. Incidentally, in FIG. 7, the same components as those illustrated in FIG. 1 carry the same reference numerals.

In FIG. 7, the itinerary proposal system 1 according to the second example embodiment includes a travel content accumulation unit 10b, a content presentation unit 35, and an itinerary correction unit 40 in addition to the components according to the first example embodiment (see FIG. 1).

The travel content accumulation unit 10b is configured to accumulate a plurality of travel contents. The travel content accumulation unit 10b collects and accumulates the travel contents, for example, by crawling on the Internet. Alternatively, the travel content accumulation unit 10b may accumulate travel contents that are manually inputted. In addition, the travel content accumulation unit 10b systematizes and accumulates a plurality of travel contents on the basis of the relevance thereof, as in the itinerary sample accumulation unit 10. Specifically, the travel content accumulation unit 10b systematizes and accumulates a plurality of travel contents by using the ontology technology/technique. Incidentally, the travel content accumulation unit 10b may be configured as the same storage apparatus as the itinerary sample accumulation unit 10.

The content presentation unit 35 is configured to present a travel content searched for and extracted by the search extraction unit 20 (hereinafter referred to as a “proposed content” as occasion demands) to a system user. The search extraction unit 20 in the second example embodiment is configured to search for a travel content that matches the inputted traveler data from the plurality of travel contents accumulated in the travel content accumulation unit 10b and to extract it as the proposed content. Specifically, the search extraction unit 20 extracts the travel content that matches the traveler data by the concept search, by utilizing the fact that the travel content accumulation unit 10b systematizes and accumulates the plurality of travel contents. The search extraction unit 20 extracts, for example, not only a travel content related to a keyword included in the traveler data, but also a travel content related to a keyword associated with the above-described keyword. The search extraction unit 20 may extract a plurality of travel contents. The content presentation unit 35 outputs and presents the proposed content extracted in this manner, at a display apparatus provided with a display.

The itinerary correction unit 40 is configured to correct the proposed itinerary presented by the itinerary presentation unit 30. Specifically, the itinerary correction unit 40 corrects the proposed itinerary by replacing a part of the travel contents included in the proposed itinerary with the proposed content presented in the content presentation unit 35. Incidentally, the itinerary correction unit 40 typically performs correction on the proposed itinerary (in other words, replacement of the travel contents) by the operation of the system user. The proposed itinerary corrected by the itinerary correction unit 40 is configured to be presented again by the itinerary presentation unit 30.

### (Flow of Operation)

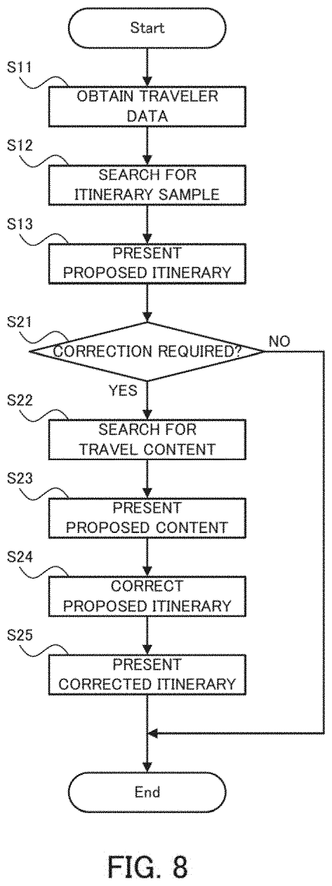

Next, with reference to FIG. 8, a flow of operation of the itinerary proposal system 1 according to the second example embodiment will be described. FIG. 8 is a flowchart illustrating the flow of the operation of the itinerary proposal system according to the second example embodiment. Incidentally, in FIG. 8, the same steps as those illustrated in FIG. 3 carry the same reference numerals.

As illustrated in FIG. 8, the itinerary proposal system 1 according to the second example embodiment firstly performs the step S11 to the step S13 in the same manner as in the first example embodiment. Thereafter, the itinerary proposal system 1 according to the second example embodiment determines whether or not it is required to correct the presented proposed itinerary (step S21). For example, when a new condition is inputted after the proposed itinerary is presented by the trip presentation unit 30, it may be determined that it is required to correct the presented proposed itinerary. Incidentally, when it is determined that it is not required to correct the proposed itinerary (the step S21: NO), the subsequent process is omitted and a series of operation steps is ended.

On the other hand, when it is determined that it is requierd to correct the proposed itinerary (the step S21: YES), the search extraction unit 20 searches for the travel content on the basis of the traveler data (wherein newly inputted data may be used in addition to the already inputted data) (step S22). Specifically, the search extraction unit 20 performs the concept search on the travel contents accumulated in the travel content accumulation unit 10b to extract the travel content that matches the traveler data. Thereafter, the content presentation unit 35 presents the travel content extracted by the search extraction unit 20 as the proposed content (step S23).

A staff of a travel agency uses the proposed content to perform an operation of correcting the proposed itinerary that is already proposed. In response to this operation, the itinerary correction unit 40 corrects the proposed itinerary (step S24). Then, the itinerary presentation unit 30 presents the corrected proposed itinerary (step S25).

### (Specific Example of Itinerary Correction)

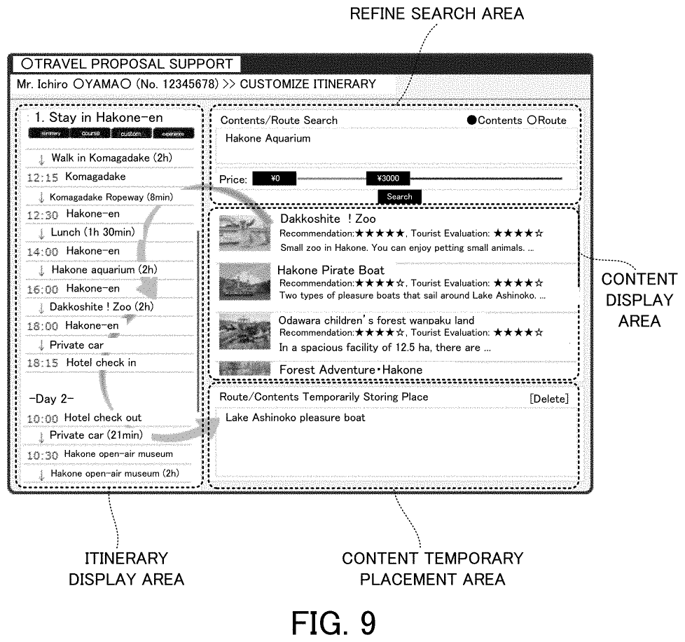

Next, with reference to FIG. 9, the correction of the itinerary that can be realized by the itinerary proposal system 1 according to the second example embodiment will be described with a specific example. FIG. 9 is an image diagram illustrating a specific example of the itinerary correction in the itinerary proposal system according to the second example embodiment.

As illustrated in FIG. 9, when the itinerary is corrected, a customized screen including an itinerary display area, a refine search area, a content display area, and a content temporary placement area is displayed on the itinerary presentation unit 30. The itinerary display area displays the proposed itinerary. The refine search area performs a display for inputting a new condition (e.g., a keyword and an upper/lower limit of a charge). The search extraction unit 20 may perform the concept search on the travel contents (i.e., the step S22 in FIG. 8) in accordance with the condition inputted here. The content display area displays a plurality of proposed contents extracted by the search extraction unit 20, in a scrollable condition. The content temporary placement area displays a travel content that is temporarily placed (and the temporary placement will be described below).

When the itinerary is corrected, for example, the travel content displayed in the content display area may be dragged and dropped on the itinerary display area. Then, the travel content of the proposed itinerary displayed in the itinerary display area is replaced with the proposed content displayed in the content display area by the itinerary correction unit 40. In this case, a route and a stay time may be changed automatically. Furthermore, when a bulk discount or the like is not applied due to the replacement of the travel contents, an alert or the like may be displayed.

The travel content deleted from the proposed itinerary by the correction is temporarily placed in the content temporary placement area. When the travel content displayed in the content temporary placement area is dragged and dropped on itinerary display area, the travel content that is temporarily placed is replaced with the travel content included in the proposed itinerary. Therefore, even the travel content that is deleted once can be easily returned to the proposed itinerary. Furthermore, when the travel content displayed in the content display area is dragged and dropped on the content temporary placement area, the travel content is temporarily placed in the content temporary placement area. Therefore, it is also possible to temporarily place the proposed content that is an additional candidate for the proposed itinerary.

### (Technical Effect)

Next, a technical effect obtained by the itinerary proposal system 1 according to the second example embodiment will be described.

As described in FIG. 7 to FIG. 9, in the itinerary proposal system 1 according to the second example embodiment, the proposed itinerary can be corrected by using the proposed content. Therefore, even if the proposed itinerary presented at the beginning is not satisfactory, it is possible to correct it to a more appropriate itinerary. Furthermore, the proposed content to be used for the correction is extracted as a result of the concept search, as in the proposed itinerary. Therefore, it is possible to correct the proposed itinerary by using the travel content that matches a traveler's preference.

### Third Example Embodiment

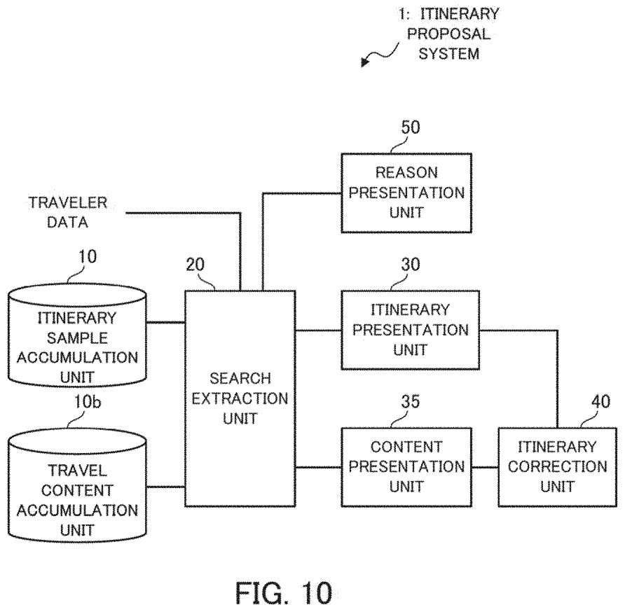

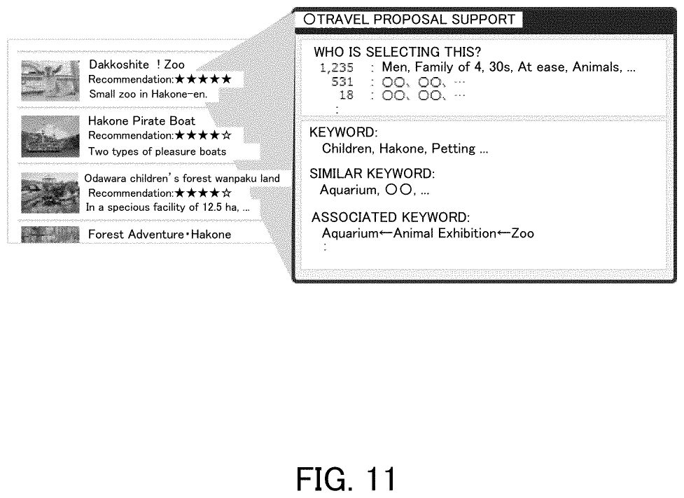

Next, the itinerary proposal system 1 according to a third example embodiment will be described with reference to FIG. 10 and FIG. 11. The third example embodiment is partially different from the first and second example embodiments described above only in the configuration and operation, and is substantially the same in the other parts. Therefore, the parts that differ from the first and second example embodiments will be described in detail below, and the other overlapping parts will not be described as occasion demands.

### (System Configuration)

First, with reference to FIG. 10, an overall configuration of the itinerary proposal system 1 according to a third example embodiment will be described. FIG. 10 is a block diagram illustrating the overall configuration of the itinerary proposal system according to the third example embodiment. Incidentally, in FIG. 10, the same components as those illustrated in FIG. 7 carry the same reference numerals.

In FIG. 10, the itinerary proposal system 1 according to the third example embodiment includes a reason presentation unit 50 in addition to the components according to the second example embodiment (see FIG. 7).

The reason presentation unit 50 is configured to present a reason why the proposed itinerary is presented. Specifically, the reason presentation unit 50 presents a reason why the search extraction unit 20 extracts the itinerary sample from the itinerary sample accumulation unit 10 (e.g., information indicating what type of search is used for extraction). Incidentally, the reason presentation unit 50 may present not a reason for the proposed itinerary itself, but a reason for each travel content included in the proposed itinerary. Furthermore, the reason presentation unit 50 may be configured to present a reason why the proposed content is presented. Specifically, the reason presentation unit 50 may be configured to present a reason why the search extraction unit 20 extracts the travel content from the travel content accumulation unit 10b. There may be a plurality of reasons presented by the reason presentation unit 50.

The reason presentation unit 50 may present the reason of the proposal, for example, at a timing when the itinerary presentation unit 30 presents the proposed itinerary or at a timing when the content presentation unit 35 presents the proposed content. Alternatively, the reason presentation unit 50 may present the reason why the proposed itinerary or the proposed content is proposed, in accordance with the operation of the system user. The reason presentation unit 50 may present the reason why the travel content is proposed, for example, when a particular travel content is selected by the system user from the proposed itinerary or the proposed content. Incidentally, the reason presentation unit 50 outputs and presents the reason why the proposed itinerary or the proposed content is proposed, at a display apparatus provided with a display. The reason of the proposal may be displayed on the same display as that for the proposed itinerary, the proposed content, or the like.

### (Specific Examples of Reason Presentation)

Next, with reference to FIG. 11, the presentation of the reason why the itinerary or content that can be realized by the itinerary proposal system 1 according to the third example embodiment is proposed will be described with a specific example. FIG. 11 is an image diagram illustrating a specific example of the reason presentation in the itinerary proposal system according to the third example embodiment.

As illustrated in FIG. 11, the reason presentation unit 50 presents the travel content and the proposed content included in the proposed itinerary and the reason why they are proposed. An example of the reason includes the number of travelers who select the same travel content, information about the travelers, a keyword used by the search extraction unit 20 for the search, a similar keyword, an associated keyword, (i.e., a keyword associated with the keyword included in the traveler data), and the like. In particular, since the search extraction unit 20 performs the search by using the concept search, it is possible to appropriately understand the reason why the proposed itinerary or the proposed content is proposed, by presenting the associated keyword. Incidentally, the reason presentation unit 50 may display a conceptual graph from the keyword to the associated keyword.

### (Technical Effect)

Next, a technical effect obtained by the itinerary proposal system 1 according to the third example embodiment will be described.

As described in FIG. 10 and FIG. 11, in the itinerary proposal system 1 according to the third example embodiment, the reason why the proposed itinerary or the proposed content is proposed is presented. Accordingly, according to the itinerary proposal system 1 in the third example embodiment, the system user (i.e., a staff of a travel agency or a traveler) can find out the reason why the proposed itinerary or the proposed content is proposed. Such a technical effect is remarkably demonstrated when the concept search using the ontology technology is performed. For example, even when an unexpected itinerary and an unexpected travel content are proposed by the associated keyword, it is possible to understand what type of search is used to extract them. As a result, the system user can be satisfied with the content of the proposed itinerary and the proposed content.

### Fourth Example Embodiment

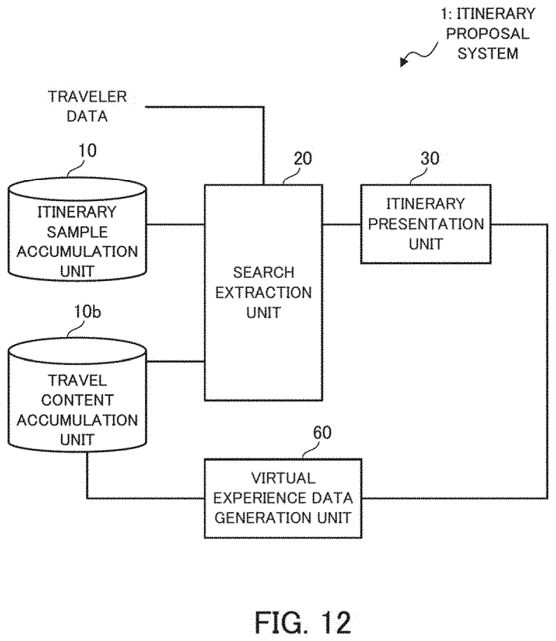

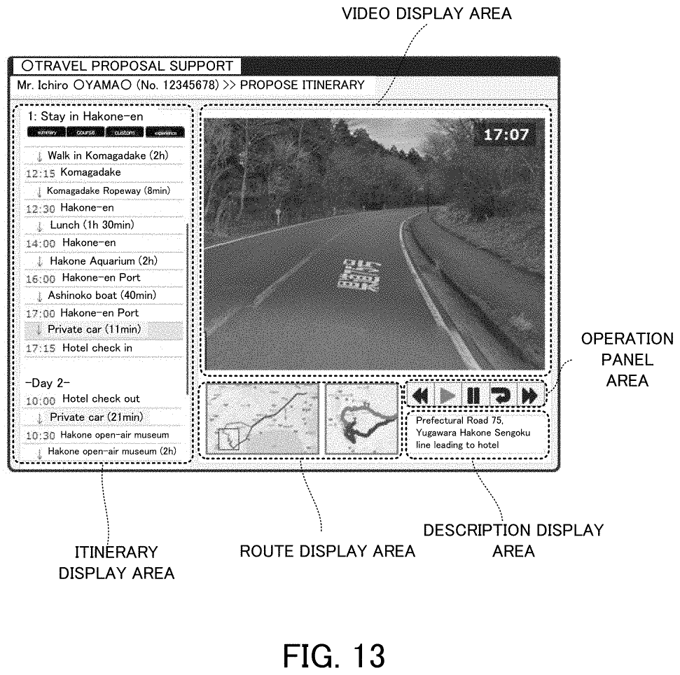

Next, the itinerary proposal system 1 according to a fourth example embodiment will be described with reference to FIG. 12 and FIG. 13. The fourth example embodiment is partially different from the first to third example embodiments described above only in the configuration and operation, and is substantially the same in the other parts. Therefore, the parts that differ from the first to third example embodiments will be described in detail below, and the other overlapping parts will not be described as occasion demands.

### (System Configuration)

First, with reference to FIG. 12, an overall configuration of the itinerary proposal system 1 according to the fourth example embodiment will be described. FIG. 12 is a block diagram illustrating the overall configuration of the itinerary proposal system according to the fourth example embodiment. Incidentally, in FIG. 12, the same components as those illustrated in FIG. 7 carry the same reference numerals.

In FIG. 12, the itinerary proposal system 1 according to the fourth example embodiment includes the travel content accumulation unit 10b and a virtual experience data generation unit 60 in addition to the components according to the first example embodiment (see FIG. 1).

The virtual experience data generation unit 60 is configured to generate and output virtual experience data for virtually experiencing the proposed itinerary presented by the itinerary presentation unit 30. The virtual experience data generation unit 60 generates the virtual experience data by using the travel contents accumulated in the travel content accumulation unit 10b. Alternatively, the virtual experience data generation unit 60 may newly collect data for generating the virtual experience data from the Internet or the like to generate the virtual experience data. The virtual experience data includes images about the travel contents included in the proposed itinerary, and images indicating a state of a route between the travel contents included in the proposed itinerary.

The virtual experience data generation unit 60 may output the virtual experience data, for example, at a timing when the itinerary presentation unit 30 presents the proposed itinerary. Alternatively, the virtual experience data generation unit 60 may output the virtual experience data in accordance with the operation of the system user (in other words, at a timing when the system user desires to output the virtual experience data). The virtual experience data outputted from the virtual experience data generation unit 60 are presented by the itinerary presentation unit 30 together with or in place of the proposed itinerary.

### (Presentation Example of Virtual Experience Data)

Next, with reference to FIG. 13, a presentation example of the virtual experience data that can be realized by the itinerary proposal system 1 according to the fourth example embodiment will be described with a specific example. FIG. 13 is an image diagram illustrating the presentation example of the virtual experience data generated by the itinerary proposal system according to the fourth example embodiment.

As illustrated in FIG. 13, when the virtual experience data are presented, a screen including an itinerary display area, a video display area, a route display area, an operation panel area, and a description display area is displayed. The itinerary display area displays the proposed itinerary corresponding to the virtual experience data. The video display area displays a video (or an image) included in the virtual experience data. The route display area displays a route(s) corresponding to the proposed itinerary. Of the routes displayed in the route display area, a route corresponding to the video displayed in the video display area may be highlighted. The operation panel area displays an operation panel for performing various operations related to the reproduction of the video displayed in the video display area. The description display area displays a description corresponding to the video displayed in the image display area.

### (Technical Effect)

Next, a technical effect obtained by the itinerary proposal system 1 according to the fourth example embodiment will be described.

As described in FIG. 12 and FIG. 13, in the itinerary proposal system 1 according to the fourth example embodiment, the virtual experience data generated on the basis of the proposed itinerary is outputted. The virtual experience data are presented to a traveler along with the proposed itinerary. Therefore, according to the itinerary proposal system 1 in the fourth example embodiment, it is possible to let the traveler to whom the proposed itinerary is presented, virtually experience the proposed itinerary. By utilizing the virtual experience data, it is possible to provide a traveler with such information that specifically images a travel and that stimulates the travel motivation.

### Fifth Example Embodiment

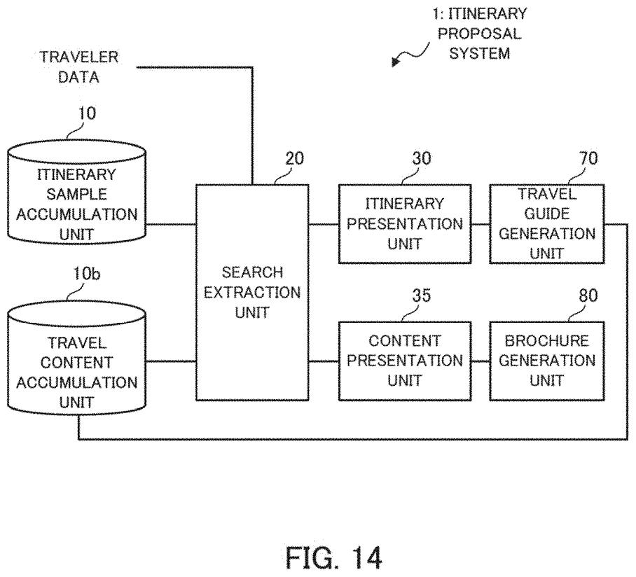

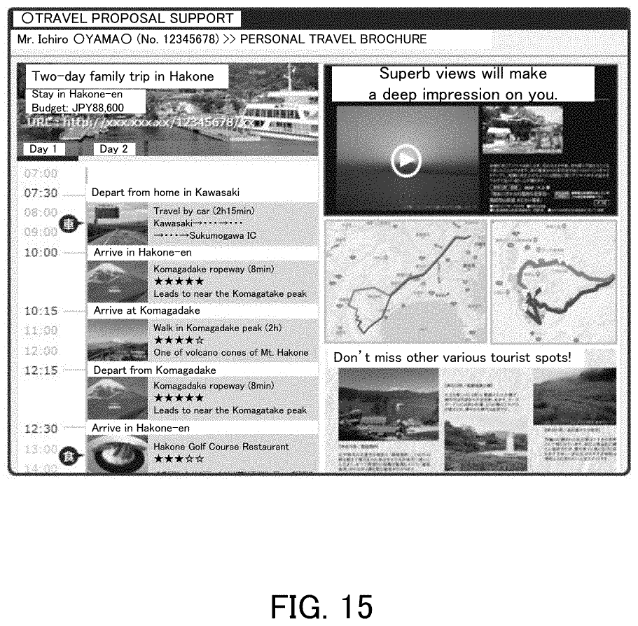

Next, the itinerary proposal system 1 according to a fifth example embodiment will be described with reference to FIG. 14 and FIG. 15. The fifth example embodiment is partially different from the first to fourth example embodiments described above only in the configuration and operation, and is substantially the same in the other parts. Therefore, the parts that differ from the first to fourth example embodiments will be described in detail below, and the other overlapping parts will not be described as occasion demands.

### (System Configuration)

First, with reference to FIG. 14, an overall configuration of the itinerary proposal system 1 according to the fifth example embodiment will be described. FIG. 14 is a block diagram illustrating the overall configuration of the itinerary proposal system according to the fifth example embodiment. Incidentally, in FIG. 14, the same components as those illustrated in FIG. 7 carry the same reference numerals.

In FIG. 14, the itinerary proposal system 1 according to the fifth example embodiment includes a travel guide generation unit 70 and a brochure generation unit 80 in addition to the components according to the second example embodiment (see FIG. 7).

The travel guide generation unit 70 is configured to generate a travel guide corresponding to the proposed itinerary presented by the itinerary presentation unit 30. Incidentally, the “travel guide” here is a summary of information for introducing the proposed itinerary, and includes information about the proposed itinerary and information about the travel contents included in the proposed itinerary (e.g., an image and an introductory essay for conveying the attractiveness of the proposed itinerary and the travel contents included therein). The travel guide generation unit 70 generates a travel guide corresponding to the proposed itinerary by using the travel contents accumulated in the travel content accumulation unit 10b.

The brochure generation unit 80 is configured to generate a brochure corresponding to the proposed content presented by the content presentation unit 35. Incidentally, the “brochure” here is a summary of information for introducing the proposed content and includes information about the proposed content (e.g., an image and an introductory essay for conveying the attractiveness of the proposed content). The brochure generation unit 80 generates a brochure corresponding to the proposed content by using the proposed content presented by the content presentation unit 35.

The generated travel guide and brochure are provided to a traveler as electronic data. The travel guide and brochure are provided to a traveler, for example, as those that are accessible at a terminal owned by the traveler.

### (Example of Brochure)

Next, with reference to FIG. 15, the travel guide and the brochure generated by the itinerary proposal system 1 according to the fourth example embodiment will be described with a specific example. FIG. 15 is an image diagram illustrating an example of the brochure generated by the itinerary proposal system according to the fifth example embodiment.

As illustrated in FIG. 15, the travel guide and the brochure are preferably configured in such a manner as to raise a traveler's travel motivation (e.g., including a catchy image and introductory essay that introduce contents included in the itinerary), as well as s common travel brochure. The configuration and layout of the travel guide and the brochure are typically determined automatically on the basis of preset items, but may be also corrected by a staff of a travel agency as appropriate. Incidentally, since the travel guide and the brochure are electronic data, it is also possible to incorporate dynamic contents such as a moving image, a walkthrough, a link, and the like. Also, the travel guide and the brochure may be accompanied by an electronic coupon that allows a discount of a charge for the travel contents.

### (Technical Effect)

Next, a technical effect obtained by the itinerary proposal system 1 according to the fifth example embodiment will be described.

As described in FIG. 14 and FIG. 15, in the itinerary proposal system 1 according to the fifth example embodiment, the travel guide corresponding to the proposed itinerary or the brochure corresponding to the proposed content is generated. Therefore, according to the itinerary proposal system 1 in the fifth example embodiment, the provision of the travel guide and the brochure makes it possible to raise a traveler's travel motivation for the proposed itinerary. Furthermore, since a traveler can take back the travel guide and the brochure, the traveler can consider the proposed itinerary even at home and elsewhere. This also makes it possible to consider the proposed itinerary with the traveler's family who also goes on a trip together.

### Supplementary Notes

With respect to the example embodiments described above, the following Supplementary Notes will be further disclosed.

### (Supplementary Note 1)

An itinerary proposal system described in Supplementary Note 1 is an itinerary proposal system including: an accumulation unit that systematizes and accumulates itinerary samples, each of which includes a plurality of travel contents, on the basis of relevance of the travel contents; an extraction unit that searches for and extracts the itinerary sample that matches an inputted condition, from the systematized and accumulated itinerary samples; and a presentation unit that presents the extracted itinerary sample as a proposed itinerary.

### (Supplementary Note 2)

An itinerary proposal system described in Supplementary Note 2 is the itinerary proposal system described in Supplementary Note 1, wherein the accumulation unit systematizes and accumulates the travel contents on the basis of the relevance of the travel contents, the extraction unit searches for and extracts the travel content that matches the inputted condition, from the systematized and accumulated travel contents, and the presentation unit presents the extracted travel content as a proposed content in addition to the proposed itinerary.

### (Supplementary Note 3)

An itinerary proposal system described in Supplementary Note 2 is the itinerary proposal system described in Supplementary Note 2, further including a correction unit that corrects the proposed itinerary by replacing the travel contents included in the proposed itinerary with the proposed content.

### (Supplementary Note 4)

An itinerary proposal system described in Supplementary Note 4 is the itinerary proposal system described in any one of Supplementary Notes 1 to 3, wherein the presentation unit presents a reason why the proposed itinerary is extracted by the extraction unit.

### (Supplementary Note 5)

An itinerary proposal system described in Supplementary Note 5 is the itinerary proposal system described in Supplementary Note 4, wherein the extraction unit searches for the travel content that matches the inputted condition by using an associated keyword associated with the inputted condition, and the presentation unit presents the associated keyword as at least a part of the reason.

### (Supplementary Note 6)

An itinerary proposal system described in Supplementary Note 6 is the itinerary proposal system described in any one of Supplementary Notes 1 to 5, further including an output unit that outputs virtual experience data including images about the travel contents included in the proposed itinerary and images indicating a state of a route between the travel contents included in the proposed itinerary.

### (Supplementary Note 7)

An itinerary proposal system described in Supplementary Note 7 is the itinerary proposal system described in any one of Supplementary Notes 1 to 6, further including a travel guide generation unit that obtains first content data about the travel contents included in the proposed itinerary and that generates the proposed itinerary by using the first content data.

### (Supplementary Note 8)

An itinerary proposal system described in Supplementary Note 8 is the itinerary proposal system according to described in Supplementary Note 2 or 3, further including a brochure generation unit that obtains second content data about the proposed content and that generates a brochure for introducing the proposed content by using the second content data.

### (Supplementary Note 9)

An itinerary proposal method described in Supplementary Note 9 is an itinerary proposal method including: systematizing and accumulating itinerary samples, each of which includes a plurality of travel contents, on the basis of relevance of the travel contents; searching for and extracting the itinerary sample that matches an inputted condition, from the systematized and accumulated itinerary samples; and presenting the extracted itinerary sample as a proposed itinerary.

### (Supplementary Note 10)

A computer program described in Supplementary Note 10 is a computer program that operates a computer to systematize and accumulate itinerary samples, each of which includes a plurality of travel contents, on the basis of relevance of the travel contents; to search for and extract the itinerary sample that matches an inputted condition, from the systematized and accumulated itinerary samples; and to present the extracted itinerary sample as a proposed itinerary.

The present invention is not limited to the examples described above and is allowed to be changed, if desired, without departing from the essence or spirit of the invention which can be read from the claims and the entire specification. An itinerary proposal system, an itinerary proposal method, and a computer program with such modifications are also intended to be within the technical scope of the present invention.

### DESCRIPTION OF REFERENCE CODES

1 Itinerary proposal system
10 Itinerary sample accumulation unit
10b Travel content accumulation unit
20 Search extraction unit
30 Itinerary presentation unit
35 Content presentation unit
40 Itinerary correction unit
50 Reason presentation unit
60 Virtual experience data generation unit
70 Travel guide generation unit
80 Brochure generation unit

What is claimed is:

1. An itinerary proposal system comprising:
at least one memory that is configured to store instructions; and
at least one processor that is configured to execute instructions
to systematize and accumulate itinerary samples, each of which includes a plurality of travel contents, on the basis of relevance of the travel contents;
to search for and extract the itinerary sample that matches an inputted condition, from the systematized and accumulated itinerary samples; and
to present the extracted itinerary sample as a proposed itinerary.

2. The itinerary proposal system according to claim 1, wherein
the processor systematizes and accumulates the travel contents on the basis of the relevance of the travel contents,
the processor searches for and extracts the travel content that matches the inputted condition, from the systematized and accumulated travel contents, and
the processor presents the extracted travel content as a proposed content in addition to the proposed itinerary.

3. The itinerary proposal system according to claim 2, further comprising a processor that is configured to execute instructions to the proposed itinerary by replacing the travel contents included in the proposed itinerary with the proposed content.

4. The itinerary proposal system according to claim 1, wherein the processor presents a reason why the proposed itinerary is extracted by the extraction unit.

5. The itinerary proposal system according to claim 4, wherein
the processor searches for the travel content that matches the inputted condition by using an associated keyword associated with the inputted condition, and
the processor presents the associated keyword as at least a part of the reason.

6. The itinerary proposal system according to claim 1, further comprising a processor that is configured to execute instructions to output virtual experience data including images about the travel contents included in the proposed itinerary and images indicating a state of a route between the travel contents included in the proposed itinerary.

7. The itinerary proposal system according to claim 1, further comprising a processor that is configured to execute instructions to obtain first content data about the travel contents included in the proposed itinerary and generate the proposed itinerary by using the first content data.

8. The itinerary proposal system according to claim 2, further comprising a processor that is configured to execute instructions to obtain second content data about the proposed content and generate a brochure for introducing the proposed content by using the second content data.

9. An itinerary proposal method comprising:
systematizing and accumulating itinerary samples, each of which includes a plurality of travel contents, on the basis of relevance of the travel contents;
searching for and extracting the itinerary sample that matches an inputted condition, from the systematized and accumulated itinerary samples; and
presenting the extracted itinerary sample as a proposed itinerary.

10. A non-transitory recording medium on which a computer program that allows a computer to execute an itinerary proposal method is recorded, the itinerary proposal method comprising:
systematizing and accumulating itinerary samples, each of which includes a plurality of travel contents, on the basis of relevance of the travel contents;
searching for and extracting the itinerary sample that matches an inputted condition, from the systematized and accumulated itinerary samples; and
presenting the extracted itinerary sample as a proposed itinerary.
